(19) United States
(12) Patent Application Publication
(10) Pub. No.: US 2011/0192420 A1
(43) Pub. Date: Aug. 11, 2011

(54) CLEANING APPARATUS AND METHOD OF FABRICATING SEMICONDUCTOR DEVICE

(76) Inventors: Nobuyuki KURASHIMA, Kanagawa-ken (JP); Gaku Minamihaba, Kanagawa-ken (JP)

(21) Appl. No.: 13/020,088

(22) Filed: Feb. 3, 2011

(30) Foreign Application Priority Data
Feb. 5, 2010 (JP) P2010-024261

(51) Int. Cl. B08B 1/00; B08B 3/00

(52) U.S. Cl. 134/6; 134/157

(57) ABSTRACT

In one embodiment, a cleaning apparatus, including, supporting bodies supporting and rotating a substrate, each of a first and a second cleaning member, having a circular shape and rotating around a rotational symmetry axis, periphery portions of the cleaning members being able to contact to opposed surfaces of the substrate, each of a first brush-cleaning member and a second brush-cleaning member having a groove with a V-shape cross section being widened upwards, a brush with a cleaning function being formed on a slope plane of the groove, the cleaning members being able to shift to contact to the slope planes, respectively, first cleaning solution supply portions supplying a first cleaning solution dispersed resin particles to the surfaces, and second cleaning solution supply portions supplying a second cleaning solution to peripheries of the cleaning members and which are arranged to contact to the slope planes, respectively.

### CROSS REFERENCE TO RELATED APPLICATION

This application is based upon and claims the benefit of priority from prior Japanese Patent Application No. 2010-24261, filed on Feb. 5, 2010, the entire contents of which are incorporated herein by reference.

### FIELD

Exemplary embodiments described herein generally relate to a cleaning apparatus and a method of fabricating a semiconductor device using the cleaning apparatus.

### BACKGROUND

Conventionally, scrub cleaning has been performed as a method for cleaning a substrate surface of a semiconductor substrate, a display substrate or the like. In a scrub cleaning process, a member constituted with a sponge brush or the like is scrubbed to the substrate surface, providing pure water or the like.

For example, a roll cleaning apparatus or a scrub cleaning apparatus is used as the cleaning apparatus in which a roll-type sponge as the cleaning member is scrubbed on the surface of the semiconductor substrate or the like.

In the scrub cleaning process, the cleaning member is directly contacted on the semiconductor substrate or the like to clean the semiconductor substrate or the like. Therefore, when a contamination object is included in the cleaning member itself, the cleaning member acts as a contamination source, so that decreasing cleaning effect on the semiconductor substrate or the like is caused.

The contaminated cleaning member is exchanged with new one for maintaining cleaning effect as one approach. However, it is necessary that the cleaning apparatus is worked out and a new cleaning member is provided in exchanging the cleaning member, so that running cost is increased. Accordingly, the contaminated cleaning member is scrubbed to a quartz substrate or the like to remove the contamination, for example.

Further, a cleaning solution in which resin particles are dispersed is used in the scrub cleaning process. In such a manner, a method as a process after CMP (Chemical Mechanical Polishing) is disclosed. In the method, a solid contamination such as a polishing particle, a polishing product or the like adhered on the surface of the semiconductor substrate or the like is removed.

However, using the cleaning solution including the dispersed resin particles in the disclosed method may force the resin particles to be the contamination object for the cleaning member.

A problem is generated that the method of removing by scrubbing the contaminated cleaning member with the solid contamination to the quartz substrate or the like is insufficient for sustaining a cleaned state of the cleaning member.

### BRIEF DESCRIPTION OF THE DRAWINGS

FIG. 1 is a schematic plane view showing a structure of a polishing system including a cleaning apparatus according to an embodiment;

FIG. 2 is a schematic perspective view showing the cleaning apparatus according to the embodiment;

FIG. 3 is a schematic view showing a constitution of the cleaning apparatus according to the embodiment, FIG. 3A is a front view, and FIG. 3B is a cross-sectional view an enlarged part of the cleaning apparatus as shown in FIG. 3A.

FIG. 4 is a cross-sectional view showing a method of fabricating a semiconductor device in order of processing steps according to the embodiment;

FIG. 5 is a table showing relationship between a resin particle diameter in cleaning solution of the cleaning apparatus, and an adhered material and a residual particle;

FIG. 6 is a graph showing cleaning effect of the cleaning apparatus according to the embodiment as compared to a comparative example.

### DETAILED DESCRIPTION

In one embodiment, a cleaning apparatus, including, supporting bodies supporting and rotating a substrate, a first cleaning member and a second cleaning member, each of the cleaning member having a circular shape and rotating around a rotational symmetry axis, periphery portions of the first cleaning member and the second cleaning member being able to contact to opposed surfaces of the substrate to be processed each other, the substrate being supported by the supporting bodies, a first brush-cleaning member and a second brush-cleaning member, each of the brush-cleaning members having a groove with a V-shape cross section being widened upwards, a brush with a cleaning function being formed on a slope plane of the groove, the first cleaning member and the second cleaning member being able to shift to contact to the slope planes of the grooves in the first brush-cleaning member and the second brush-cleaning member, respectively, first cleaning solution supply portions supplying a first cleaning solution dispersed resin particles to the surfaces to be processed, and second cleaning solution supply portions supplying a second cleaning solution to peripheries of the first cleaning member and the second cleaning member which are arranged to contact to the slope planes of the first brush-cleaning portion and the second brush-cleaning portion, respectively.

In another embodiment, a method of fabricating a semiconductor device, including, forming a film to be processed on a semiconductor substrate, polishing the film to be processed, contacting both a surface on which the film is formed and a back surface opposed each other of the semiconductor substrate to periphery portions of the first cleaning member and the second cleaning member, respectively, supplying a first cleaning solution dispersed the resin particles to clean the semiconductor substrate, shifting the contacting portions, shifting the first cleaning member and the second cleaning member to positions of a first brush-cleaning member and a second brush-cleaning member, respectively, each of the brush-cleaning members setting to be apart from the semiconductor substrate and having a groove with a V-shaped cross section being widened upwards, a slope plane on the groove being a cleaning surface with a brush, contacting periphery portions of the first cleaning member and the second cleaning member to the clean surface of the brush-cleaning members, and supplying a second cleaning solution to clean the first cleaning member and the second cleaning member, shifting the contacting portions.

A Embodiment will be described below in detail with reference to the attached drawings mentioned above. Throughout the attached drawings, similar or same reference numerals show similar, equivalent or same components.

### Embodiment

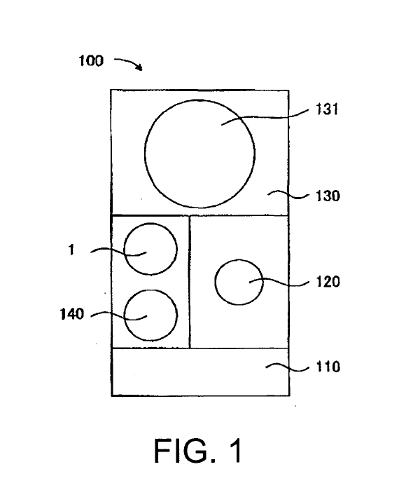

A cleaning apparatus and a method of cleaning a cleaning member according to an embodiment is described in detail with reference to FIGS. 1-6. The cleaning apparatus is a roll cleaning apparatus or a scrub cleaning apparatus which uses a roll sponge as the cleaning member.

As shown in FIG. 1, a cleaning apparatus 1 is used as one apparatus in a polishing system 100, for example. The polishing system 100 includes a carrier gateway 110 carrying a substrate in and out, a carrier system 120, a polishing apparatus 130, the cleaning apparatus 1, and pencil-cleaning and spin-drying apparatus 140. The substrate means a semiconductor substrate 11 mentioned below and is not shown in FIG. 1.

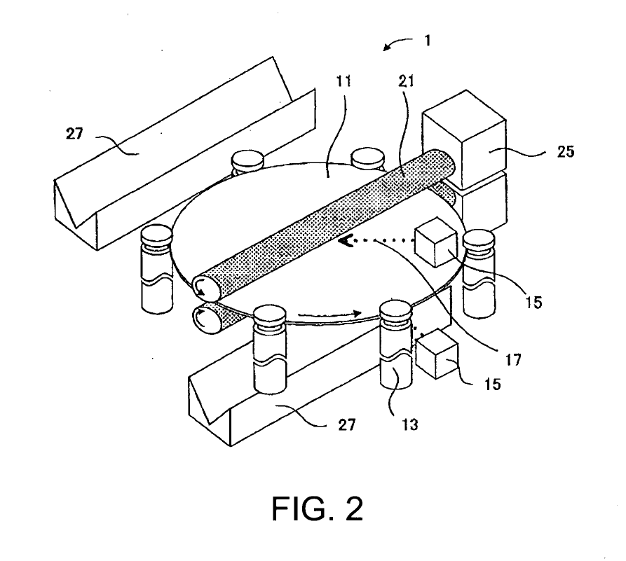

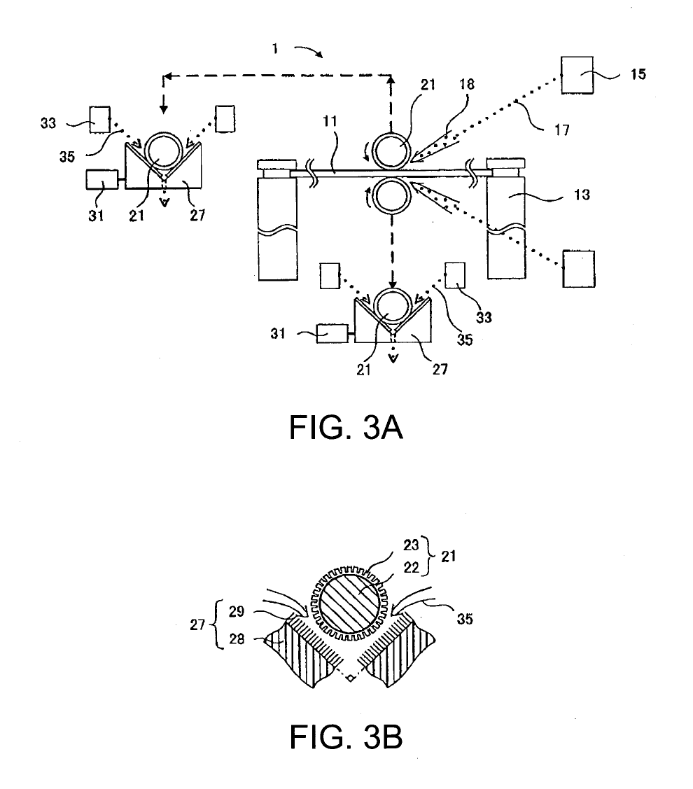

In a fabricating process, for example, a cassette (not shown) is set in the carrier gateway 110. The semiconductor substrates 11 in one lot which is constituted with twenty-five substrates, for example, are installed. Each semiconductor substrate 11 in the cassette is carried into the polishing apparatus 130 by the carrier system 120. A surface and a back surface of the semiconductor substrate are polished on the polishing table 131, for example, by CMP. After polishing in the polishing apparatus 130, the semiconductor substrate 11 is carried out from the polishing apparatus 130 and carried into the cleaning apparatus 1 by the carrier system 120. Scrub cleaning is performed on the surface and the back surface of the semiconductor substrate in the cleaning apparatus 1 by using the roll member 21 (shown in FIGS. 2 and 3).

After finishing scrub cleaning in the cleaning apparatus 1, the semiconductor substrate 11 is carried out from the cleaning apparatus 1 and carried into the pencil-cleaning and the spin-drying apparatus 140 by the carrier system 120. Pencil-brush-cleaning is performed on the surface of the semiconductor substrate 11 in the pencil-cleaning and spin-drying apparatus 140. Subsequently, the semiconductor substrate 11 is rotated with high speed to splash water by centrifugal force, so that the semiconductor substrate 11 is spin-dried. The semiconductor substrate 11 spin-dried is carried out and into the carrier gateway 110 by the carrier system 120 to be returned in the original cassette.

As shown in FIGS. 2 and 3, the cleaning apparatus 1 includes rotation supporters 13, brush-cleaning members 27, roll members 21, a scrub cleaning solution supply portions 15 which are first cleaning solution supply portions, and pure water supply portions 33 which are second cleaning solution supply portions. The rotation supporters 13 support and rotate the semiconductor substrate 11 as the substrate. The brush-cleaning members 27 are arranged at an opposite side of the semiconductor substrate 11 to the rotation supporters 13 and a lower side apart from the semiconductor substrate 11, respectively. Each of the brush-cleaning members 27 has a cleaning surface which is formed as a slope plane with a cross-sectional V-shape which is a groove opened upward. The brush-cleaning member 27 includes a brush portion 29 formed on the surface of the groove. The roll members 21 include a first cleaning member and a second cleaning member, which are located upward and downward to the substrate, respectively. Each of the roll members 21 has a cylindrical shape rotating around isotropic rotation symmetry axis. A periphery portion of each roll member 21 can contact with the surfaces opposed each other of the semiconductor substrate 11 to be processed which supported by the rotation supporter 13. Further, the roll member 21 contacts to the slope plane with the cross-sectional V-shape of the brush-cleaning member 27. Each of the scrub cleaning solution supply portion 15 supplies a scrub cleaning solution 17 as a first cleaning solution dispersed resin particles 18 onto the surface of the semiconductor substrate 11 to be processed. Each of the pure water supply portion 33 supplies pure water 35 as a second cleaning solution onto the periphery portion of the roll member 21, which is located to contact to the brush portion 29 on the slope plane with the cross-sectional V-shape at plural positions.

The semiconductor substrate 11 is not restricted to a semiconductor wafer but includes a substrate in which a necessary structure is formed on the surface of the semiconductor device. Further, the semiconductor substrate 11 is not restricted to silicon as a main portion but includes a compound semiconductor, an oxide substrate or the like having a semiconductor film which is grown on a surface thereof. The semiconductor substrate 11 can be replaced with various kinds of substrates, a glass substrate, for example, a substrate of a liquid crystal display, an organic EL (Electroluminescence) display, a plasma display or the like, a substrate for a photo disc such, for example, a resin substrate, a substrate for magnetic disc, for example, an aluminum substrate, a photo-mask substrate, for example, a glass substrate or the like.

The rotation supporters 13 support the periphery portion of the semiconductor substrate 11 which is nearly a circular shape. The rotation supporters 13 can be rotated in a horizontal plane. The rotation supporters 13 are located at positions without contacting with the roll member 21. The six positions, for example, are arranged by nearly equal interval, however, are not restricted to the number and the positions.

The roll member 21 has nearly a cylindrical shape with a curved side surface and both bottom surfaces with a circular shape. The roll members 21 are located upward and downward to the semiconductor substrate 11 and the side surfaces of the roll members 21 is set to be in parallel to the surface and the back surface opposed each other of the semiconductor substrate 11, respectively. The roll member 21 covers a diameter of the semiconductor substrate 11. Each roll member 21 is supported with a roll member supporter 25. The roll member 21 shifts along the vertical line of the roll member supporter 25 so as to close and separate with the semiconductor substrate 11, so that the roll member 21 can change a position to a state contacting or no contacting to the semiconductor substrate 11. The roll member supporter 25 can control pressure by which the roll member 21 presses the semiconductor substrate 11 along the vertical line. The roll member supporter 25 provides rotational driving force to the roll member 21 by setting the center of the both bottom surface of the roll member 21 as an axis which is the isotropic rotation axis of the cylinder shape.

One of the brush-cleaning members 27 is arranged at an opposite side position of the semiconductor substrate 11 to the rotation supporters 13 (called an outer side, hereinafter) and the other is arranged at a lower position apart from the semiconductor substrate 11 (called a lower side, hereinafter). The roll member supporter 25 enable the roll member 21 at the outer side to cross over the rotation supporter 13 so as to shift to the position of brush-cleaning member 27 at the outer side and to shift the roll member 21 at the lower side to the position of the brush-cleaning member 27 at the lower side.

The scrub cleaning solution supply portions 15 are arranged obliquely upward and downward for avoiding immediately above and below the semiconductor substrate 11 to supply the scrub cleaning solution 17 in which the resin particles 18 are dispersed to an upper and a lower contacting portions between each of the surfaces of the semiconductor substrates 11 and each of the roll members 21, respectively. Each of the scrub cleaning solution supply portions 15, for example, includes an injection portion with a nozzle type to be able to supply the scrub cleaning solution 17 apart from the scrub cleaning solution supply portion 15. The plurality of the scrub cleaning solution supply portions 15 can be arranged at both upper and lower sides along the contacting portion between the surface of the semiconductor substrate 11 and the roll member 21.

Pure water is used as the scrub cleaning solution 17, for example, however, ion-exchange water through ion-exchange resin can be used. Further, a solution containing a component which proceeds to clean a contaminant can be used.

A material, for example, polymethylmethacrylate (PMMA), polystyrene (PS), polyethylene (PE), polyethyleneglycol, polyvinyl acetate, polybutadiene, polyisobutylene, polypropylene, polyoxymethylene or the like can be selected as the resin particle 18. The resin particle 18 can be constituted with single material or mixed materials more than two kinds. As mentioned later, a primary particle diameter of the resin particle 18 is selected in a range of 10 to 60 nm.

As shown in FIG. 3A, each of the pure water supply portions 33 is closely arranged at the brush-cleaning member 27 so as to able to supply pure water 35 to a contacting portion between the roll member 21 and the brush-cleaning member 27. The pure water supply portion 33 is arranged at both sides of the brush-cleaning member 27 along two contacting portions between the roll member 21 and the brush-cleaning member 27 to enable the roll member 21 to sift upward and downward without problem.

As shown in FIG. 3B, the roll member 21 includes a core portion 22 with nearly a cylindrical shape which passes between each center portion of the both bottom surfaces. A sponge portion 23 is fixed on a sidewall of the core portion 22. A thickness of the sponge portion 23 is nearly equal to the outermost periphery portion. In the sponge portion 23, for example, circular protrusions are distributed on a surface of the sidewall to occupy nearly a half of the area. Each circular protrusion has a diameter of nearly a few mm and a height of nearly the radius of the circle, respectively. The sponge portion 23, for example, is porous PVA (Polyvinyl Acetate). On the other hand, the sponge portion 23 may be urethane foam or the like. Further, the protrusion of the sponge portion 23 can be omitted.

The brush-cleaning member 27 includes a base portion 28 in which a V-shaped groove opened upward is formed. The brush portion 29 is formed on the slope plane constituting the groove of the base portion 28. Fine bristles are formed on the brush portion 29. The bristles are constituted with resin which is harder than the sponge portion 23. The leading edge of each bristle is rounded and the bristles are perpendicularly distributed on the slope plane of the base portion 28. The fine bristle in this embodiment indicates to have a larger length than the diameter from the surface. On the other hand, the fine bristle is not necessary but the diameter can be relatively larger than the length, namely, convex and concave is distributed in the surface of the brush portion 29. The length of the brush portion 29 is desirable to be just long enough to over the height of the convex and concave in the sponge portion 23. Further, the slope plane constituting the groove of the base portion 28 is not necessary to be formed in integrated fashion at the bottom of the groove, but isolated slope planes can be located at intervals.

A through hole which can pass to the bottom surface side is opened at the bottom portion of the V-shaped groove in the brush-cleaning member 27 to enable the pure water 35 or the like to flow out. The bottom portion is the lowest position of the base portion 28. The pure water 35 supplied from an upper portion runs the surface of the brush-cleaning member 27 or the like to fall down to the through hole by one way. Further, when the V-shaped groove has a slope which is lowered towards outside of the brush-cleaning member 27, the through hole is not necessary.

The brush-cleaning member 27 can contact with the roll member 21 at the two surfaces of V-shaped groove. Further, the brush-cleaning member 27 is connected to an ultrasonic generator 31 to enable the brush portion 29 to vibrate in a state contacting with the roll member 21. A length of the brush-cleaning member 27 is longer than the length along the rotation axis of the roll member 21. The length of the brush-cleaning member 27 is desirable to be at least longer than a portion of the roll member 21 which contacts with the semiconductor substrate 11. Further, the brush-cleaning member 27 can be provided vibration with smaller frequency than ultrasonic wave. The brush-cleaning member 27 can be rolled to scrub an external periphery portion of the roll member 21.

Next, a method for cleaning the roll member 21 of the cleaning apparatus 1 is described. As shown in FIG. 3, the roll members 21 interleave the semiconductor substrate 11 from one above the other. The scrub cleaning solution 17 within dispersed resin particles 18 is supplied to the contacting surface. The contacting surface is cleaned with accompanying rotating as shown by real allow directions. After finishing cleaning, the roll member 21 is sifted at a position of the brush-cleaning member 27 in a state that the roll member 21 is fixed to the roll member supporter 25. Further, the roll member 21 is cleaned, for example, at a first step in a roll cleaning process, successively, the semiconductor substrate 11 as the starting substrate in the lot can be set at the cleaning apparatus 1. The contacting surface of the semiconductor substrate 11 is not substantively polished in cleaning by using the cleaning apparatus 1.

The roll member 21 at the upper side is carried at a position of the brush-cleaning member 27 at the outer side, for example, sifting upward from the surface of the semiconductor substrate 11, outside and downward as shown by the broken arrows to be arranged at the brush portion 29 of the groove of the brush-cleaning member 27. Accordingly, the roll member 21 contacts with each of the two portions of the brush portion 29. The roll member 21 at the lower side is arranged at a position of the brush-cleaning member 27 at the lower side, for example, sifting downward from the semiconductor substrate 11 as shown by the dotted arrows. Accordingly, the roll member 21 is located on the brush portion 29 of the groove of the brush-cleaning member 27 to contact with the two portions of the brush portion 29. The semiconductor substrate 11 after cleaning is shifted by the carrier system 120.

The roll member 21 is rotated by a driving force from the roll member supporter 25 in a state that the roll member 21 is contacted with the brush-cleaning member 27 at the two portion, in other word, in a state that the roll member 21 is pressed to the brush-cleaning member 27. The pure water 35 is supplied from the pure water supply portion 33 to clean the roll member 21. Vibration by the ultrasonic generator 31 is added on the brush-cleaning member 27. The pure water 35, a solid contamination included in the pure water 35 and the resin particle 18 are flowed in one way to be discharged from the through hole formed in the bottom portion of the V-shaped groove of the brush-cleaning member.

After finishing to clean the roll member 21 by the brush-cleaning member 27, ultrasonic wave, rotation, press, pure water 35 or the like is stopped, and the roll member 21 is returned along the reverse direction of the broken and dotted arrows. Before the roll members 21 interleaves from one above the other, the semiconductor substrate 11 is carried into the position by the carrier system 120 and is set on the rotation supporter 13. After that, next semiconductor substrate 11 is repeatedly carried into the position via cleaning the semiconductor substrate 11, carrying out the semiconductor substrate 11 and cleaning the roll member 21. After cleaning the final semiconductor substrate 11, it is desirable to perform cleaning the roll member 21.

Next, an example which the cleaning apparatus 1 is applied to a fabricating process of a semiconductor device is described. Effects are evaluated by comparison with a fabricating process of a comparative example.

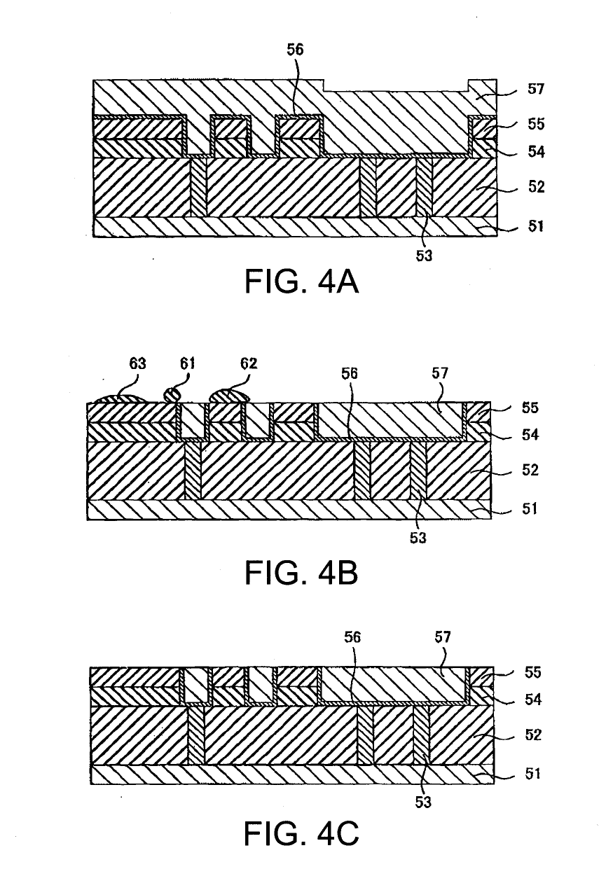

As shown in FIG. 4A, a barrier metal film 56 and a wiring material film 57 are deposited on a semiconductor wafer 51 via an inorganic insulator 52, a laminated insulator of a first 54 and a second insulator 55. A semiconductor element formed on a surface of the semiconductor wafer 51 is not illustrated.

Plugs 53 constituted with tungsten (W) are embedded in the insulator 52. The laminated insulator is constituted with the first insulator 54 with relative permittivity of less than 2.5 and the second insulator 55 formed on the first insulator with relative permittivity being larger than that of first insulator 54. Thicknesses of both the first insulator 54 and the second insulator 55 are set to be 100 nm.

The first insulator 54 can be formed using at least one selected from groups of a film having siloxane skeleton such as polysiloxane, hydrogen silsesquioxane, polymethylsiloxane, methysilsesquioxane or the like, a film having organic resin as a main component such as polyarylether, polybenzoxazole, polybenzocyclobutene or the like, and a porous film such as porous silica film or the like. The first insulator 54 constituted with such a material is brittle.

The second insulator 55 acts as a cap insulator, and can be formed by using, for example, an insulator at least one selected from a group, having relative permittivity more than 2.5, of SiC, SiCH, SiCN, SiOC, SiN, and SiOCH. A surface of the second insulator 55 constituted with such a material has hydrophobicity. Further, an insulator such as SiO, SiOP, SiOF, SiON or the like, which has hydrophilicity, may be adhered as a residue in the surface after finishing CMP. The scrub cleaning solution 17 with dispersed resin particles 18 can be suited to such an insulator in this embodiment.

After a wiring groove is formed in the laminated insulator mentioned above, the barrier metal film 56 and the wiring material film 57 are wholly deposited. The barrier metal film 56 with a film thickness of 10 nm can be formed by using Ta, and the wiring material film 57 with a film thickness of 400 nm can be formed by using Cu.

As shown in FIG. 4A, the insulator on which the barrier metal film 56 and the wiring material film 57 are formed is a layered structure with the first insulator 54 and the second insulator 55. On the other hand, a single layer insulator can be used. In this case, the insulator, for example, can be formed by black diamond (Applied Materials Co. Ltd.) or the like. The insulator constituted with such a material also includes a surface having hydrophobicity.

Next, an unnecessary portion of the barrier metal film 56 and the wiring material film 57 is removed by CMP as shown in FIG. 4B to expose a surface of the second insulator 55. CMP is carried out by two steps, removing the wiring material film 57 as the first polishing step and removing the barrier metal film 56 as the second polishing step. The conditions are mentioned below. A material having the films or the like thereon is called the semiconductor substrate 11.

(First Polishing Step)

Slurry: CMS7401/7452 (JSR Co., Ltd.)

Flow Rate: 300cm³/min;

Polishing Pad: IC1000 (NITTA HAAS Inc.);

Load: 300 gf/cm² (2.9E4Pa);

A number of rotations of both a carrier fixing the semiconductor substrate 11 (not shown) and a polishing table 131 are set to be 100 rpm, and the sample is polished for one minute.

(Second Polishing Process)

Slurry: CMS8401/8452 (JSR Co., Ltd.)

Flow Rate: 200 cm³/min;

Polishing Pad: IC1000 (NITTA HAAS Inc.);

Load: 300 gf/cm² (2.9E4Pa);

A number of rotations of both the carrier fixing the semiconductor substrate 11 (not shown) and the polishing table 131 are set to be 100 rpm, and the sample is polished for thirty seconds.

After immediately finishing the second polishing step as shown in FIG. 4B, materials such as a polishing particle 61, a polishing product 62, a watermark 63 or the like is adhered to the second insulator 55, the barrier metal film 56 and the wiring material film 57. The adhered material such as the polishing particle 61, the polishing product 62, the water mark 63 or the like causes a defect.

As shown in FIG. 4C, a clean surface is obtained by cleaning to remove these adhered materials using the cleaning apparatus 1 according to the embodiment.

Here, an experiment is performed mentioned below for investigating an optimum range of a primary particle diameter of the resin particle. Particles, each having a deferent primary particle diameter, constituted with PMMA are prepared as the resin particle. The primary particle diameter of the resin particle can be measured by using a photograph, for example, obtained from SEM (Scanning Electron Microscope) or TEM (Transmission Electron Microscope). Removing the adhered materials is carried out by using each resin particle with a primary particle diameter being 5 nm-100 nm.

Specifically, using each scrub cleaning solution dispersed with the resin particle, the surface at each step as shown in FIG. 4B is cleaned by conditions mentioned below. The roll member 21 is contacted to the surface to be processed to scrub 30-60 seconds in the cleaning process by using the cleaning apparatus 1.

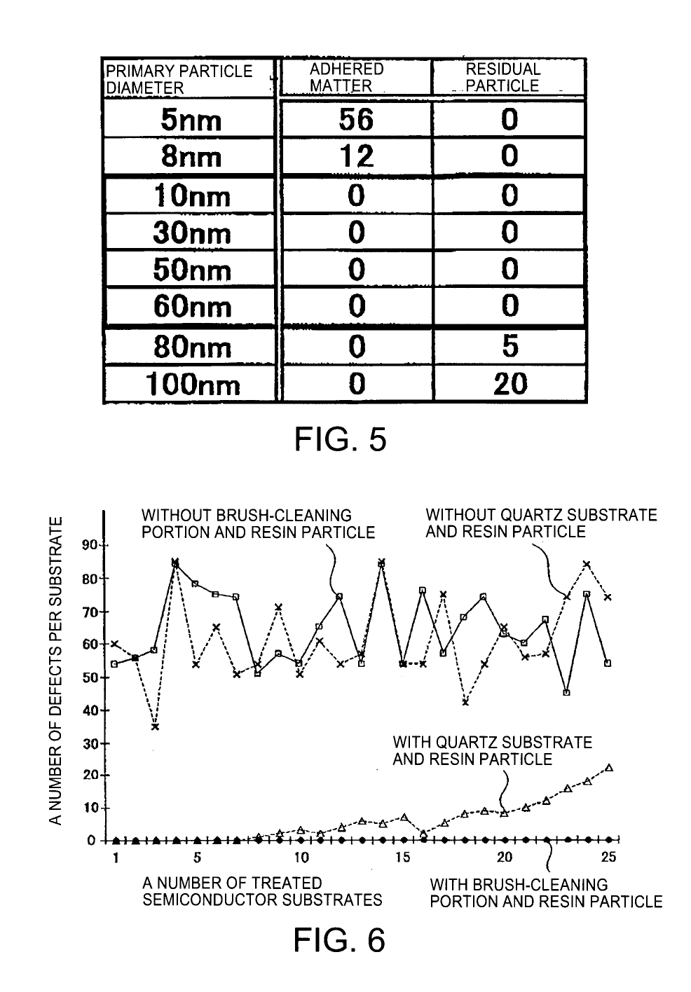

Conditions in the cleaning process are mentioned below. Scrub cleaning solution flow rate is 300 cm³/min, and a number of both the semiconductor substrate 11 and the roll member 21 is 100 rpm. As shown in FIG. 5, the results which show a dependence of the primary particle diameter of the resin particle are obtained by measuring objects for removing which are contaminants corresponded to the adhered matter and residual resin particles by using a bright field defect measurement apparatus. A number of the objects for removing are shown as per one semiconductor substrate. The resin particle with primary particle diameter being less than 10 nm cannot sufficiently obtain scrub cleaning effect. On the other hand, when the primary particle diameter is over 60 nm, the resin particles theirselves are leaved on the surface to be processed. The residues may cause the defect. The primary particle diameter from 10 nm to 60 nm is a range in which the residual contaminations and the residual resin particles become zero. The primary particle diameter of the resin particle 18 is in the range from 10 nm to 60 nm. Further, the primary particle of the diameter resin particle 18 is favorable from 30 nm to 50 nm.

Further, as shown in FIG. 6, a defect number on the semiconductor substrate 11 of comparable examples are evaluated using a cleaning apparatus similar to the cleaning apparatus 1. The comparable examples are combined with a case that the resin particle is not dispersed in the scrub cleaning solution and a case that the brush-cleaning member 27 is replaced with a plane quartz substrate. Scratch damages or the like other than adhered solid materials are also included in the defect number. The primary particle diameter of the resin particle 18 is nearly 50 nm. Twenty-five substrates per lot are shown in processed order along the horizontal axis and the defect number per semiconductor substrate 11 is shown along the vertical axis. The quarts substrate is horizontally located by replacing with the brush-cleaning member 27 as shown in FIG. 3 to contact to the roll member 21 at one upper portion. The pure water 35 is supplied from the both side of the pure water supply portions 15 to the contacting portion between the roll member 21 and the quarts substrate as same as the roll member 21.

The result processed by the cleaning apparatus 1 in this embodiment indicates, as black circles, the defect number is zero over the twenty-five substrates per lot. On the other hand, the result, in which the scrub cleaning solution 17 is used in the cleaning apparatus similar to the cleaning apparatus 1 and the brush-cleaning member 27 is replaced with the plane quartz substrate, indicates that the defect number continues to be zero halfway in one lot, subsequently, the defect number is gradually increase in just enough to twenty as shown by triangles.

The results in which the scrub cleaning solution without dispersing the resin particle 18 is used in the cleaning apparatus similar to the cleaning apparatus 1 is indicated by square marks or cross marks. The defect number fluctuates between thirty-five and eighty-five without almost relationship to the brush-cleaning member 27 and the plane quartz substrate. These result reveals that the resin particle 18 is greatly contributed to clean the semiconductor substrate 11 and cleaning effect can be maintained by using the brush-cleaning member 27. Reversely, the method of scrubbing the roll member 21 on the quartz substrate is indicated to be insufficient under the condition of cleaning by the brush-cleaning member 27. As the solid contaminations and the resin particles are accumulated in the roll member 21, the method of scrubbing of the roll member 21 on the quartz substrate is, for example, necessary for cleaning in longer time.

The brush portion 29 is formed on the surface contacted to the roll member 21 in the brush-cleaning member 27 and can be constantly contact to the roll member 21 on the two portions. The brush-cleaning member 27 can quickly clean the roll member 21 as compared to the quartz substrate by having convex and concave with further difference in height, a number of contacting portions, the pure water 35 including adhered solid materials flowing one way or the like, or combination with theirs.

As mentioned above, the cleaning apparatus 1 uses the scrub cleaning solution 17 with the dispersed resin particles 18 which has the primary particle diameter from 10 nm to 60 nm and the roll member 21 so as to clean the surface of the semiconductor substrate 11. Further, the cleaning apparatus 1 cleans the surface of the roll member 21 using the brush-cleaning member 27 having brush portion 29 on the surface of the V-shaped groove and the pure water 35 between cleaning processes of the surface of the semiconductor substrate 11.

The cleaning apparatus 1 can constantly clean the solid contaminations including the resin particles 18 adhered to the roll member 21. As the surface of the semiconductor substrate 11 is cleaned by the cleaned roll member 21, the surface of the semiconductor substrate 11 carried in orders can be continually cleaned. In other word, the roll member 21 is controlled to prevent accumulation of the solid contaminations. As the defects on the surface are decreased, a yield of the semiconductor devices in the process can be controlled to avoid deterioration. Further, a usable period of the roll member 21 till exchanging the roll member 21 can be extended. Accordingly, the cleaning apparatus 1 can be suppressed on a fabricating cost of the semiconductor device.

In the embodiment, the brush-cleaning member having the V-shaped slope plane in which the two planes are set to be an angle of nearly ninety degree is described, for example. However, when a roll member can be contacted to two planes and can be sift in and out to an upper and lower direction of the V-shaped groove, the two planes formed as the V-shaped plane can be suited larger or smaller than ninety degrees. Both of the two planes formed as the V-shaped plane are formed as a plane, for example. On the other hand, a curved surface can be used.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cleaning apparatus, comprising:
supporting bodies supporting and rotating a substrate;
a first cleaning member and a second cleaning member
each of the cleaning member having a circular shape and rotating around a rotational symmetry axis, periphery portions of the first cleaning member and the second cleaning member being able to contact to opposed surfaces of the substrate to be processed each other, the substrate being supported by the supporting bodies;
a first brush-cleaning member and a second brush-cleaning member
each of the brush-cleaning members having a groove with a V-shape cross section being widened upwards, a brush with a cleaning function being formed on a slope plane of the groove, the first cleaning member and the second cleaning member being able to shift to contact to the slope planes of the grooves in the first brush-cleaning member and the second brush-cleaning member, respectively;
first cleaning solution supply portions supplying a first cleaning solution dispersed resin particles to the surfaces to be processed; and
second cleaning solution supply portions supplying a second cleaning solution to peripheries of the first cleaning member and the second cleaning member which are arranged to contact to the slope planes of the first brush-cleaning portion and the second brush-cleaning portion, respectively.

2. The cleaning apparatus of claim 1, wherein
the slope plane of the groove in the brush-cleaning member is formed in integrated fashion and a through hole is formed on a bottom of the groove.

3. The cleaning apparatus of claim 1, wherein
the peripheries of the first cleaning member and the second cleaning member are formed by a porous sponge portion with a convex and concave shape.

4. The cleaning apparatus of claim 3, wherein
the sponge portion is composed of polyvinyl acetate or urethane.

5. The cleaning apparatus of claim 1, wherein
the brush-cleaning member is constituted with a base portion and a brush portion, the brush portion is constituted with resin which is harder than the sponge portion.

6. The cleaning apparatus of claim 1, wherein
a length of the brush portion is higher than a height of the convex and concave in the sponge portion.

7. The cleaning apparatus of claim 1, wherein
a length of the cleaning members to a rotational symmetry axis direction is longer than a diameter of the substrate.

8. The cleaning apparatus of claim 1, wherein
the first cleaning solution supply portion has an injection portion with a nozzle type.

9. The cleaning apparatus of claim 1, wherein
the resin particle includes at least one selected from a group of polymethylmethacrylate, polystyrene, polyethylene, polyethyleneglycol, polyvinyl acetate, polybutadiene, polyisobutylene, polypropylene and polyoxymethylene.

10. The cleaning apparatus of claim 1, wherein
a primary particle diameter of the resin particle is in a range from 10 nm to 60 nm.

11. The cleaning apparatus of claim 1, wherein
the first cleaning solution has water as a main component.

12. The cleaning apparatus of claim 1, wherein
the second cleaning solution has water as a main component.

13. The cleaning apparatus of claim 1, further comprising:
an ultrasonic generator.

14. A method of fabricating a semiconductor device, comprising:
forming a film to be processed on a semiconductor substrate;
polishing the film to be processed;
contacting both a surface on which the film is formed and a back surface opposed each other of the semiconductor substrate to periphery portions of the first cleaning member and the second cleaning member, respectively;
supplying a first cleaning solution dispersed the resin particles to clean the semiconductor substrate, shifting the contacting portions;
shifting the first cleaning member and the second cleaning member to positions of a first brush-cleaning member and a second brush-cleaning member, respectively, each of the brush-cleaning members setting to be apart from the semiconductor substrate and having a groove with a V-shaped cross section being widened upwards, a slope plane on the groove being a cleaning surface with a brush;
contacting periphery portions of the first cleaning member and the second cleaning member to the clean surface of the brush-cleaning members; and
supplying a second cleaning solution to clean the first cleaning member and the second cleaning member, shifting the contacting portions.

15. The method of claim 14, wherein
the resin particle includes at least one selected from a group of polymethylmethacrylate, polystyrene, polyethylene, polyethyleneglycol, polyvinyl acetate, polybutadiene, polyisobutylene, polypropylene and polyoxymethylene.

16. The method of claim 14, wherein
a primary particle diameter of the resin particle is in a range from 10 nm to 60 nm.

17. The method of claim 14, wherein
the brush-cleaning members are applied with vibration by ultrasonic in cleaning by the second cleaning solution.

18. The method of claim 14, wherein
polishing the semiconductor substrate, cleaning the semiconductor substrate, shifting the first cleaning member and the second cleaning member and cleaning the first cleaning member and the second cleaning member are performed in a polishing system.

19. The method of claim 14, wherein
lengths of the first cleaning member and the second cleaning member to rotational symmetry axis direction is longer than a diameter of the substrate to wholly clean the semiconductor substrate in cleaning.

20. A polishing system, comprising:
the cleaning apparatus of claim 1;
a polishing apparatus; and
a carrier system.
